(19) United States
(12) Patent Application Publication
(10) Pub. No.: US 2009/0283565 A1
(43) Pub. Date: Nov. 19, 2009

(54) Determination of roll media dimensions

(76) Inventors: Jose Miguel Ibanez, Barcelona (ES); Jose Antonio Alvarez, Sant Cugat del Valles (ES); Daniel Gutierrez, Bardalona (ES)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/243,506

(22) Filed: Oct. 1, 2008

Related U.S. Application Data
(60) Provisional application No. 61/054,188, filed on May 19, 2008.

(51) Int. Cl. B65H 43/00; G01B 21/12

(52) U.S. Cl. 226/10; 702/158

(57) ABSTRACT

A measurement method for roll media comprises determining media thickness as a function of a relationship between media advance and media roll rotation.

### CROSS-REFERENCE TO RELATED APPLICATION

This Utility Patent Application is based on and claims the benefit of U.S. Provisional Application No. 61/054,188, filed on May 19, 2008 the contents of which are hereby incorporated by reference in their entirety.

### BACKGROUND OF THE INVENTION

Large format printers typically impose upper limits on media width, e.g., 400 to 2000 millimeters (mm), but media lengths tend to be constrained primarily by the amount of media on a roll that feeds the media to the printer. Running out of media part way through a print job can incur costs in wasted media, wasted ink (most large format printers are inkjet or piezo printers), and time. To avoid this waste, some printer manufacturers provide for indications of remaining media length.

Manufacturers of roll media typically label the roll with its dimensions, e.g., 15 meters by 1400 mm. Some printers allow a user to enter a value for roll length into the printer when the roll is installed. During use, the length of media consumed is tracked and subtracted from the nominal roll length to yield an estimate of remaining media length.

There are several problems with this method of tracking remaining media length. First, the nominal lengths are often approximate. Second, some of the length is used to engage the feed mechanism of the printer. Third, the method does not apply well to partially used rolls. In this last case, rolls may be swapped in and out, e.g., to change media types. In theory, a user could note the remaining media length of a roll as it is swapped out and then enter that value into the printer when the roll is swapped in. In practice, the person swapping out a roll may neglect to record the tracked remaining media length. Hence, there is still a need for an approach to determining remaining media length that does not rely on the nominal lengths assigned to a roll of media.

Herein, related art is described to facilitate understanding of the invention. Related art labeled “prior art” is admitted prior art; related art not labeled “prior art” is not admitted prior art.

### BRIEF DESCRIPTION OF THE DRAWINGS

The figures depict implementations/embodiments of the invention and not the invention itself.

FIG. 1 is a combination schematic diagram and flow chart of a system and method in accordance with embodiments of the invention.

FIG. 2 is a flow chart characterizing a specific implementation of the method of FIG. 1.

### DETAILED DESCRIPTION

The present invention provides for in-use determinations of roll media dimensions. Media thickness is determined as a function of the relationship between media advance (travel distance) and feed roll rotation. Remaining media length can be determined from the media thickness and a core radius for the roll. This method works despite deviations from nominal roll lengths, variations due to media installation, and swapping of incompletely used media in and out of a printer or other media-handling device.

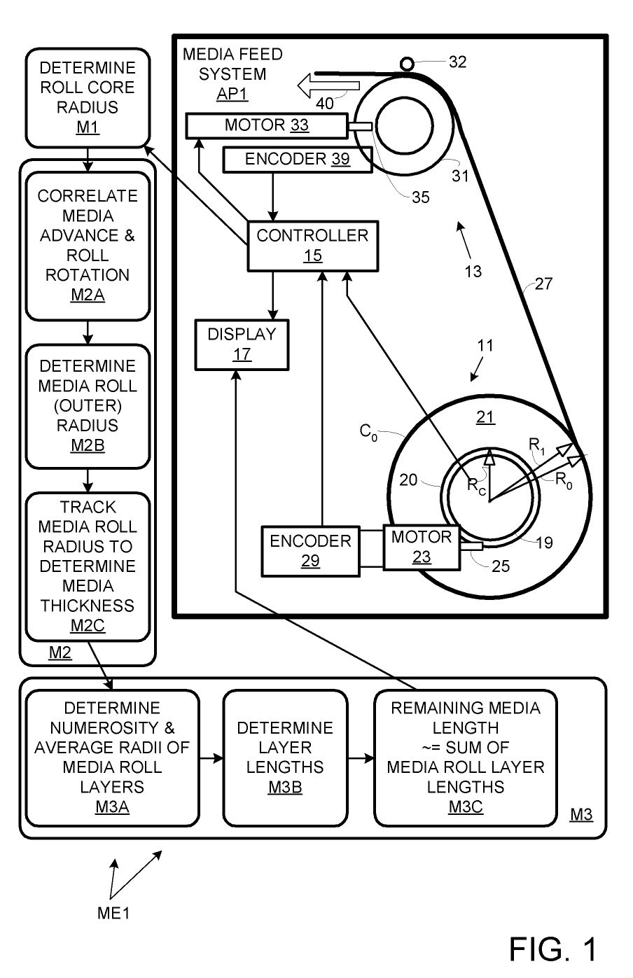

A media feed system API for a large-format inkjet printer is shown in FIG. 1 comprising a feed subsystem 11, a drive subsystem 13, a controller 15, and a display 17. Feed subsystem includes a spindle 19 on which a media roll 21 can be mounted and a feed motor 23 for driving spindle 19. Feed motor 23 includes a shaft 25 for driving spindle 19 so as to tension media 27 as it is pulled off roll 21; motor 23 also includes a rotation encoder 29 for encoding the rotational position of shaft 25 and, indirectly, spindle 19 and media roll 21.

Drive subsystem 13 includes a drive roller 31, a nip roller 32, a drive motor 33, including a drive shaft 35, and a drive encoder 39 directly attached to drive roller 32. Drive shaft 35 engages drive roller 31, so that drive roller 31 rotates counterclockwise (given the view of FIG. 1), sending media 27 in the direction of arrow 43. The purpose of drive motor 33 is to draw media 27 from roll 21 and send it in the direction shown by arrow 40. Nip roller 32 holds media 27 against drive roller 31 to ensure good contact therebetween. Drive encoder 39 tracks the rotational position of drive shaft 33, and, through scaling, the length by which media 27 is advanced in the direction of arrow 43.

As drive motor 33 rotates drive roller 31 counter-clockwise (as represented in FIG. 1), media 27 is drawn from media roll 21, which thus also rotates counter-clockwise. Feed motor 23 urges roll 21 clockwise, but the clockwise urging is overcome by the action of drive motor 31. The net effect is that media 27 is drawn from roll 21 under the force of drive motor 31 and held taught by feed motor 23. Feed encoder 29 tracks the rotation of feed shaft 25 and, through proper scaling, the rotational position of media roll 21.

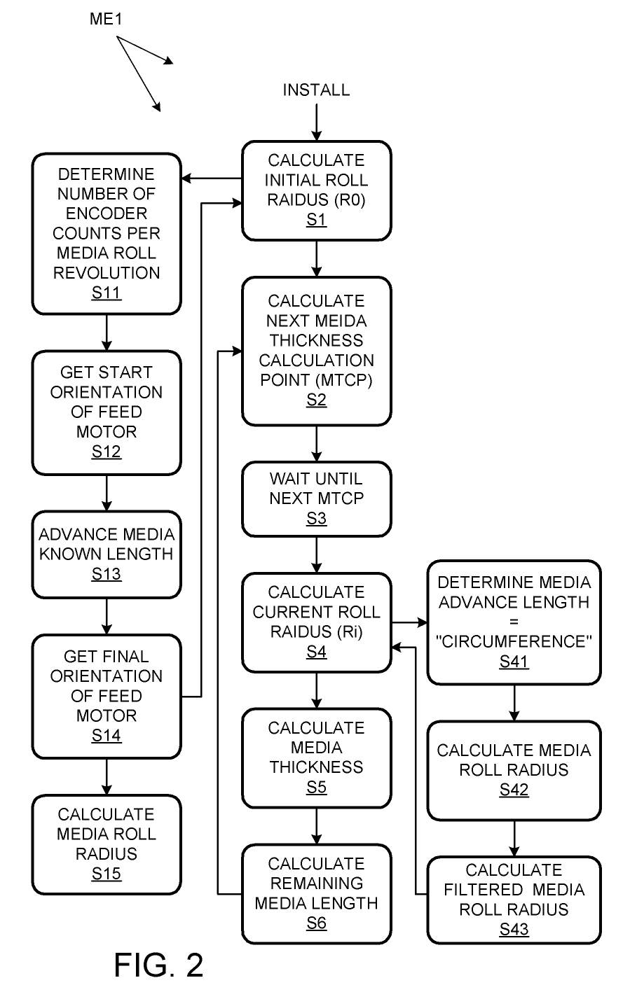

Controller 15 implements a method ME1 in accordance with an embodiment of the invention. Immediately below, method ME1 is described conceptually with reference to the flow chart of FIG. 1. A more implementation-oriented description of method ME1 is provided subsequently with reference to FIG. 2.

With reference to FIG. 1, at method segment M1, the core radius R_{c} of media roll 21 is determined, e.g., by a use manually measuring media roll core 20. Controller 15 provides a generic value for the core radius, but more accurate results are achievable using a measured value. The core radius so determined can be provided to controller 15, e.g., by manually entering the core radius using a front panel of an incorporating printer or using a software program that allows modification of print parameters, when the roll is installed. This value is used in method segment M5 below.

At method segment M2, media thickness is determined as a function of a correlation between media advance and roll rotation. At subsegment M2A, controller 15 tracks media advance and roll rotation to determine their correlation. For example, feed encoder 29 can be monitored by controller 15 to determine the start and stop times of a single full (360°) rotation of media roll 21. Concurrently, controller 15 can monitor drive encoder 29 to determine the length of media advance during that single full rotation. The media advance during a single full rotation of media roll 21 corresponds to the average (of the diminishing) circumference of roll 21 during the rotation.

In alternative embodiments employing variation of subsegment M2A, media feed systems use intervals smaller or larger than one revolution to track the relationship between media length and roll orientation. Fractional rotations can be used to achieve more rapid estimates of roll radius, while multi-rotational intervals can be used to calculate media thickness. Results from different approaches can be compared to detect anomalous results. At subsegment M2B, the average outer radius of media roll 21 during that rotation can be computed from the average circumference.

At subsegment M2C, controller 15 tracks the outer radius of roll 21 to determine media thickness. For example, the media advance during a second full rotational cycle of media role 21 can be used to calculate a second outer roll radius R1. The first (R0) and second (R1) outer roll radii can be compared. The second is smaller and the difference corresponds to the media thickness. Controller 15 provides for variations of subsegment M2C in which media thickness is determined using fractional or multiple rotations (as opposed to only single full rotations) or plural approaches at once.

At method segment M3, remaining media length is determined as a function of roll core radius, media thickness, and media roll radius. At subsegment M3A, the number (numerosity) of media layers on media roll 21 is determined, e.g., by dividing the difference between the outer radius (determined at subsegment M2B) and the core radius (determined at method segment M1) by the media thickness (determined at subsegment M2C). The numerosity determination may be explicit or implicit in the identification of the layers involved in the length calculations. For each of these layers, an average radius can be determined, e.g., as an integer number times the media thickness added to the core radius or subtracted from the outer roll radius.

At subsegment M3B, the layer lengths (roughly corresponding to circumferences) are calculated using the formula 2πR. At method segment M3B, these layer lengths can be added to provide a measure of remaining media length. This value can be adjusted by the length of media between roll 21 and drive roller 41 to provide a more accurate measure of remaining media length if desired.

A more specific description of an implementation of method ME1 is described below with reference to the flow chart of FIG. 2. At method segment S1, an initial media roll radius R0 is determined as follows. At subsegment S11, the number of encoder counts N per revolution of media roll 21 is determined as the product of 1) Mf, the feed motor to feed roller motor transmission ratio; and 2) Ef, the number N of feed motor encoder counts per revolution of motor shaft 25. At subsegment S12, the start orientation of media roll 23 is obtained in the form of an encoder count Es. At subsegment S13, media 27 is advanced X inches, which can be determined using drive encoder 35, taking into account the diameter of drive roller 41. If the encoder is attached to the motor instead of the drive roller, the drive roller transmission ratio affects this calculation; however, encoder 41 is directly attached to drive roller 31, so this consideration does not apply. At subsegment S14, the end encoder count E0 is obtained (taking into account any wrap-arounds). At method segment S15, the initial roll radius is determined according to the following formula.

R₀=X*N/(E0−Es)*2π

At method segment S2, the next media thickness calculation point is determined. This is the encoder count E₁ that will be achieved after one revolution of media roll 21. This count can be calculated as:

E₁=E₀+N.

At method segment S3, media 27 is advanced until the next media calculation point is reached. This point is one media roll revolution past the previous point. At method segment S4, the current roll radius is determined. In the first iteration, the current roll radius is R₁; for the ith iteration of method ME1, the current roll radius is Rᵢ.

Method segment S4 involves subsegment S41 of determining the media advance during the last revolution of media roll 21. This media advance is the ith circumference of media roll 21. At subsegment S42, dividing by 2π, yields the ith radius Rᵢ for media roll 21. In practice, the current roll radius can be calculated after every single movement so that we have the last filtered values at S1 and S4. For comparison purposes and to detect anomalous radius determinations, a filtered roll radius can be determined at subsegment S43 according to the following formula.

Rᵢ=X*s*z/2π+Rᵢ−1*(1−z), where 0<z<1.

The filtered value can be used in place of the unfiltered value, especially where the noise in the measurements is large. The value of z can be determined by trial and error, with 0.3 being typical.

At method segment S5, media thickness is calculated as Rᵢ−Rᵢ₋₁.

Thus, by tracking encoders 29 and 39, the relationship between media travel and roll rotation can be tracked. This relationship can be used to determine, at any given point during operation, the outer radius of media roll 21.

The media roll radius diminishes as media 27 is drawn from media roll 21. The rate of this change (as a function of media advance) indicates the thickness of media 27. If the core radius of roll 21 is known, the number of media layers between core radius R_{c} and outer radius Rᵢ can be determined, as can an average radius for each layer. The average radius for each layer can be used to determine a media length for each layer. The sum of the lengths of the media layers corresponds to the length of media remaining on roll 21. This length can be adjusted, e.g., by the distance between media roll 21 and drive roller 31, to provide a precise measure for remaining media length.

At method segment S6, remaining media length is calculated according to the following formula.

MediaLength=Σ_{R=R}_{_{C}}^{R}^{ᵢ}^{=R}^{_{i−1}}^{+M}^{_{T}}2×π×Rᵢ

where R_{C} is the roll core radius, and M_{T} is the media thickness.

Media core radius R_{C} can be determined in a variety of ways, e.g., a manual measurement by the user. In the illustrated embodiments, media length advance and roll rotation are tracked using motor position encoders. However, the invention provides for alternatives to these approaches. For example, an optical transmitter and sensor can be applied directly to the media to detect movement. Also, an encoder can detect roll orientation directly, rather than through detection of a motor shaft orientation. This last approach can be used, for example, where a spring is used instead of a feed motor to tension media. These and other variations upon and modifications to the illustrated embodiment are provided for by the present invention, the scope of which is defined by the following claims.

What is claimed is:

1. A measurement method for roll media comprising determining (M2) media thickness as a function of a relationship between media advance and media roll rotation.

2. A method as recited in claim 1 further comprising determining (M3) remaining media length as a function of media thickness and a roll media core radius (R_{c}).

3. A method as recited in claim 1 wherein said media advance and said roll rotation are determined as functions of different respective rotation encoders.

4. A method as recited in claim 1 wherein media thickness is determined in part as a function of current roll radius, which is determined as a function of a correlation between media advance and roll rotation.

5. A method as recited in claim 4 wherein said determining media thickness involves determining media thickness as a function of a roll radius.

6. A media feed system comprising:
means for tracking media advance of media on a media roll;
means for tracking rotation of said media roll; and
means for computing a thickness of said media as a function of a relationship between media advance and said rotation.

7. A system as recited in claim 6 wherein said means for computing further computes remaining media length on said roll as a function of media thickness, current roll radius, and a core radius of said roll.

8. A system as recited in claim 6 wherein said means for tracking media advance includes a rotation encoder.

9. A system as recited in claim 6 wherein said means for tracking rotation includes a rotation encoder.

10. A system as recited in claim 9 wherein said rotation encoder encodes rotational position of a motor shaft used for rotating said media roll.
